(19) United States
(12) Patent Application Publication
(10) Pub. No.: US 2020/0250584 A1
(43) Pub. Date: Aug. 6, 2020

(54) MODELING METHOD FOR SMART PROGNOSTICS AND HEALTH MANAGEMENT SYSTEM AND COMPUTER PROGRAM PRODUCT THEREOF

(71) Applicant: Marketech International Corp., Taipei City (TW)

(72) Inventors: Chien-Ming Martin Wei, Taipei City (TW); Guo-Yan FAN, Hsinchu City (TW); Wei-Huan HU, Hsinchu City (TW)

(21) Appl. No.: 16/263,660

(22) Filed: Jan. 31, 2019

(51) Int. Cl. G06N 20/10; G06N 20/20; G06K 9/62; G05B 23/02

(52) U.S. Cl. CPC G06N 20/10; G05B 23/0283; G06K 9/6215; G06N 20/20

(57) ABSTRACT

The present invention provides a modeling method for a smart prognostics and health management system. The method comprises a new tree establishing step, a dual-branch modeling step, and a model adaptive optimization step. As monitoring data increases, a golden model can be selected as a benchmark for optimization decision from prediction hypothesis models constructed by the dual-branch modeling step. This benchmark is used for next prediction. A prediction result of the system is caused to meet an expected target value. The present invention provides a computer program product for the smart prognostics and health management system at the same time. The above-described modeling method for the smart prognostics and health management system is completed when the computer program product is executed.

### FIELD OF THE INVENTION

The present invention relates to a modeling method for a smart prognostics and health management system and a computer program product thereof, in particular to a modeling method and a computer program product for an adaptively-optimized smart prognostics system.

### BACKGROUND OF THE INVENTION

In order to ensure the stability of the production process of a production machine and increase the production rate, it is necessary for the manufacturing industry to perform strict quality monitoring on an operation status of the production machine. The health statuses of equipment and parts can be monitored and evaluated by using a machine prognostics and health management technology and by analyzing machine data, and the optimal maintenance or replacement timing may be determined according to the statuses to reduce unplanned downtime and maintenance frequency.

In the prior art, critical process parameters are monitored and observed strictly in order to meet quality requirements. The so-called “critical process parameters” refer to the factors most related to equipment failures. In practice, these factors are monitored as important indicators for equipment maintenance prognostics. In order to improve the prognostics accuracy, a number of publicly available techniques have been proposed, including a selection method for leading associated parameters and a method for equipment maintenance prognostics in combination with critical parameters and leading associated parameters as proposed by the applicant in U.S. patent application Ser. No. 16/001,520, in which, after data collected by a sensor is filtered and classified into a critical parameters (CP) set and other feature parameter sets, the earliest time in which the critical parameters are affected in advance is identified from the feature parameter sets as the leading associated parameters (LAP), and an equipment maintenance prognostics model that effectively improves the early warning capability is constructed by using the CP set and the LAPs.

However, in the case of modeling the equipment maintenance prognostics model, it is necessary for the prior art to accumulate a certain amount of monitoring data and maintenance records before modeling. However, in the early days when new machine equipment is introduced into a prognostics system, engineers often could not quickly and effectively find important parameters from a small number of monitoring data without maintenance records and construct a prediction model. Therefore, there is a need to provide a modeling method and a computer program product for a smart prognostics and health management system to overcome the defects of the prior art.

### SUMMARY OF THE INVENTION

An objective of the present invention is to solve the defect that, in the early days when new machine equipment is introduced into a prognostics system, it is difficult to quickly and effectively find important parameters from a small number of monitoring data without maintenance records and construct a prediction model.

Another objective of the present invention lies in that: through a dual-branch modeling method, a golden model is selected from dual-branch models according to an adaptive optimization mechanism to perform an optimization decision, so that a prediction result of a prognostics and health management system meets an expected target value.

In order to achieve said objectives, the present invention provides a modeling method for a smart prognostics and health management system, which is performed through a smart prognostics and health management system in which a plurality of reference hypothesis models are constructed. The method comprises:

(S1) a new tree establishing step in which at least one object is defined according to a machine to be monitored, each object acquiring monitoring data via at least one monitoring point;

(S2) a dual-branch modeling step in which a data preprocessing step a is performed in a branch one to convert the monitoring data into a specified feature format, and a similarity analysis is performed to select one reference hypothesis model with the highest similarity and exceeding a specified threshold from the plurality of reference hypothesis models as a branch one prediction hypothesis model of the object; at the same time, a data preprocessing step b is performed on the monitoring data in a branch two to confirm a critical parameter (CP) and a plurality of associated parameters (AP) corresponding to the object by using a causal relationship test and construct a hypothesis model applicable to the machine to be monitored as a branch two prediction hypothesis model of the object; and

(S3) a model adaptive optimization step in which, as the monitoring data is continuously generated, after the object determines “whether the machine cannot continue the maintenance and operation”, if the determination result is “Yes”, a golden model is selected from the branch one prediction hypothesis model or the branch two prediction hypothesis model constructed by the dual-branch modeling step as a benchmark for optimization decision of the object, this benchmark is used for next prediction, and a prediction result of the system meets an expected target value.

According to an embodiment of the present invention, in the new tree establishing step, the machine to be monitored is a new machine without maintenance records.

According to an embodiment of the present invention, in the branch one of the dual-branch modeling step, the specified feature format has the same feature format as before the reference hypothesis model is constructed.

According to an embodiment of the present invention, the model adaptive optimization step, after the golden model is selected, further comprises: converting the monitoring data into the specified feature format and updating it to the reference hypothesis models constructed in the smart prognostics and health management system.

According to an embodiment of the present invention, the model adaptive optimization step further comprises: acquiring at least one maintenance record that includes a maintenance status value of at least one monitoring point, the monitoring data being in one-to-one correspondence to the maintenance record.

According to an embodiment of the present invention, in the branch one of the dual-branch modeling step, the similarity analysis uses at least one selected from a group consisting of Eucledian Distance, Mahalanobis Distance, Manhattan Distance, Minkowski distance, and Cosine Similarity, and combinations thereof, as a quantification method for the similarity analysis.

According to an embodiment of the present invention, in the branch one of the dual-branch modeling step, when the result of the similarity analysis does not exceed the specified threshold, a feature matrix composed of the CP and the APs confirmed by the branch two is first used as the basis for modeling the branch one prediction hypothesis model; and in the model adaptive optimization step, after a maintenance record label is acquired, the branch one prediction hypothesis model is reconstructed according to a supervised learning method.

According to an embodiment of the present invention, the supervised learning method includes at least one selected from a group consisting of a support vector machine (SVM), regression, random forest, and a combination thereof.

According to an embodiment of the present invention, in the model adaptive optimization step, when the branch one prediction hypothesis model is superior to the branch two prediction hypothesis model for in consecutive times, the branch one prediction hypothesis model is set as the golden model; when the branch one prediction hypothesis model is not superior to the branch two prediction hypothesis model for in consecutive times, the branch two prediction hypothesis model is selected as the golden model.

In an embodiment of the present invention, in the model adaptive optimization step, the in value is a positive integer greater than 2.

The present invention further provides a computer program product for a smart prognostics and health management system, wherein the modeling method for the smart prognostics and health management system is completed when the computer program product is executed.

Therefore, according to the system and the method provided by the present invention, it is possible to perform analysis from a small number of object monitoring data without maintenance records, find important parameters and construct a prediction model by use of object dual-branch modeling. As object monitoring data and corresponding maintenance records increase continuously, a golden model can be selected for optimization decision from an object dual-branch model through the model adaptive optimization step. The impact of important monitoring parameters on the operating status of the machine can be known under analysis, and the optimal timing for maintenance and replacement of parts can be found, thereby ensuring the process stability of the production machine and increasing the production capacity and the utilization rate.

### BRIEF DESCRIPTION OF THE DRAWINGS

FIG. 1A is an architecture diagram of a smart prognostics system according to an embodiment of the present invention.

FIG. 1B is a flowchart of a modeling method for a smart prognostics system according to an embodiment of the present invention.

FIGS. 2A and 2B are flowcharts of a data preprocessing step a and a data preprocessing step b according to an embodiment of the present invention.

FIGS. 3A and 3B are flowcharts of a similarity analysis step and a leading associated parameter analysis step according to an embodiment of the present invention.

FIG. 4 is a flowchart of a model adaptive optimization step according to an embodiment of the present invention.

### DETAILED DESCRIPTION OF THE PREFERRED EMBODIMENTS

Details and technical contents of the present invention are given with the accompanying drawings below.

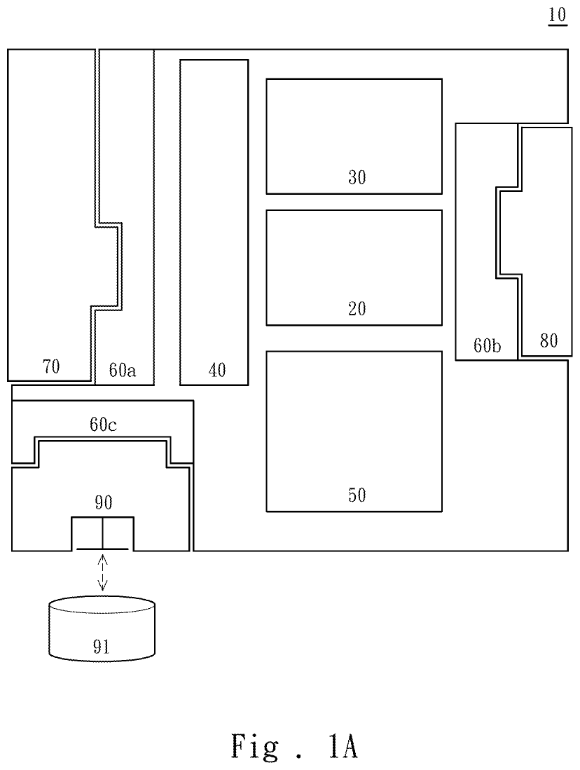

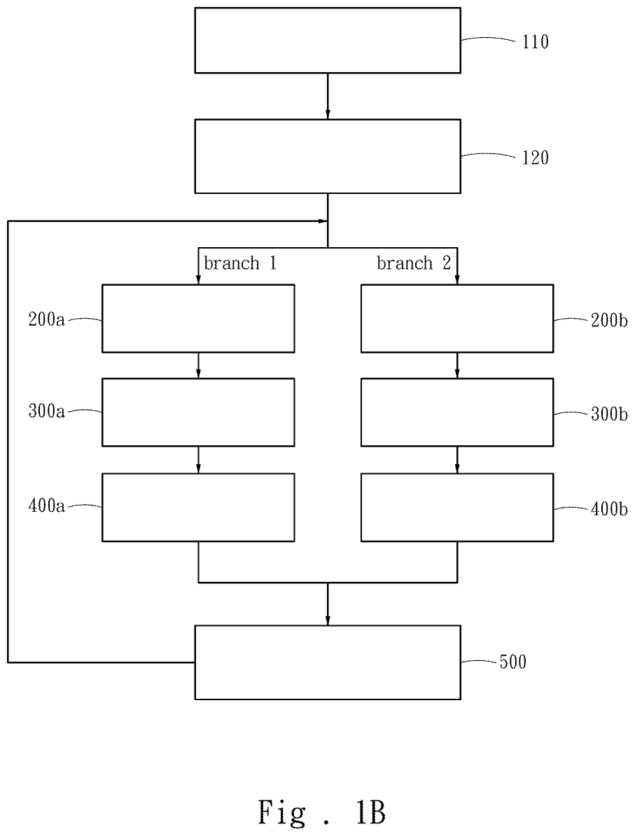

FIG. 1A is an architecture diagram of a smart prognostics system according to an embodiment of the present invention. The smart prognostics and health management (SPHM) system 10 at least comprises an analytic engine service manager (AESM) module 20, a smart prediction and health management object analysis tree (SPHM-OAT) module 30, a machine learning library module 40, and a file system module 50.

In order to make the application of the system of the present invention more expansible, the SPHM system 10 may further comprise an expansion module. The expansion module is in linkage with the SPHM-OAT module 30, and may comprise a first exchangeable application programming interface 60a, a second exchangeable application programming interface 60b, and an exchangeable driver interface 60c. The first exchangeable application programming interface 60a is connected to an external machine learning module 70; the second exchangeable application programming interface 60b is connected to an external reference model module 80; and the exchangeable driver interface 60c is connected to an external data collection drive (EDCD) 90 for acquiring raw data set in a database 91 of machine equipment to be monitored.

The analytic engine service management module 20 serves as a core of the SPHM system 10 of the present invention, and can control the status of each component in the SPHM-OAT module 30.

The SPHM-OAT module 30 is in linkage with the analytic engine service management module 20 and comprises a plurality of object analysis trees (OATs). Each OAT comprises a plurality of objects, and each object corresponds to a critical parameter (CP) and a plurality of associated parameters (AP). A health status of each object is reflected timely by specifying a SPHM health indicator (SPHM-HI) to make early warning and health management. The SPHM-HI is expansible, and examples of basic items may include next N-Run fail (NRF) indicators, remaining useful life (RUL) indicators for equipment critical components, general health indicator (HI), and other similar related health indicators. Since the functions, types, actual quantification and analysis modes of these health indicators are well known to those skilled in the art, they are not described here.

Data sources of the CP and the APs may be information acquired by a sensor, or may be aggregated from the CP and other APs of the objects. Each object is in linkage with an object control block (OCB). Each of the OCBs is used to store an operating result of the corresponding object in the analysis process, and is able to backup and restore regularly. In this way, if a disaster event occurs during the analysis, a response operation can be performed quickly via the OCBs to obtain the status of the object from the last checkpoint, and then preform the hierarchical integrated operation analysis from a sibling node to a parent node continuously in a recursive manner until the analysis of the object at the highest level (i.e., root) is completed.

Accordingly, under the premise that the monitoring data sources are correct and the selection of the CP and the APs is also correct, the SPHM system 10 of the present invention can timely reflect the health status of objects via the objects, and make early warning and health management.

The SPHM-OAT module 30 is responsible for workflow management on the objects in addition to managing the OATs representing a plurality of corresponding machines. The so-called “workflow” is managed by a mapping table, and may include a data preprocessing layer, a data hypothesis layer, and a data ensemble layer, which are stacked. The level, order, and actual work content of the workflow can be adjusted according to needs, and are not limited to the above content.

The mapping table operates via a table driven mechanism. According to a preset working method from a table, at least one suitable algorithm is selected from the machine learning library module 40 being in linkage with the SPHM-OAT module 30 for use in the workflows such as the data preprocessing layer, the data hypothesis layer, or the data ensemble layer. For example, the algorithm applicable to the data preprocessing layer may include a feature selection algorithm or a feature extraction algorithm, which has a feature selection capability; the algorithm applicable to the data hypothesis layer may include a regression algorithm, an autoregressive integrated moving average model (ARIMA) algorithm, a relative strength index (RSI) algorithm, or other algorithms having prediction capabilities; and the working method of the data ensemble layer is to vote by constructing a plurality of hypothesis models specified by the mapping table, or according to the hierarchical integrated operation specified by the current OAT. In addition, the analytic engine service management module 20 also controls the workflow for each OAT according to the mechanism of the mapping table.

The file system module 50 can serve as a place for the system to write back files and/or store the files. Examples of the “file” may include quantitative analysis information of the life cycles of the OATs in the SPHM-OAT module 30, a feature sample data set of a default reference hypothesis model set before modeling, backup data when the system fails during the calculation, or reference hypothesis to which each object belongs, so that the file system module 50 may provide information required by the SPHM-OAT module 30 when necessary.

If necessary, the system of the present invention can be expanded by connecting the expansion module to an external device. For example, when the existing data of the machine learning library module 40 is insufficient, the first exchangeable application programming interface 60a of the expansion module is connected to the external machine learning module 70 so as to expand the existing functions of the machine learning library module 40; or, the second exchangeable application programming interface 60b of the expansion module is connected to the external reference model module 80 so as to expand a hypothesis model indicators of the mapping table of the SPHM-OAT module 30 and participate in the selection and deployment of an external hypothesis model in a manual mode; in addition, the exchangeable driver interface 60c of the expansion module may be connected to an external data collection drive 90, and the external data collection drive 90 is connected to the external database 91, such that raw data stored in the external database 91 of the machine equipment to be monitored can be acquired by the external data collection drive 90.

Next, the modeling method for the SPHM system of the present invention will be described by way of an example.

First, at an initial stage of introducing the SPHM system of the present invention into a new machine, n pieces of monitoring data of the object without a maintenance record are accumulated from scratch. The monitoring data may be raw data, and each piece of monitoring data includes a plurality of monitoring parameters.

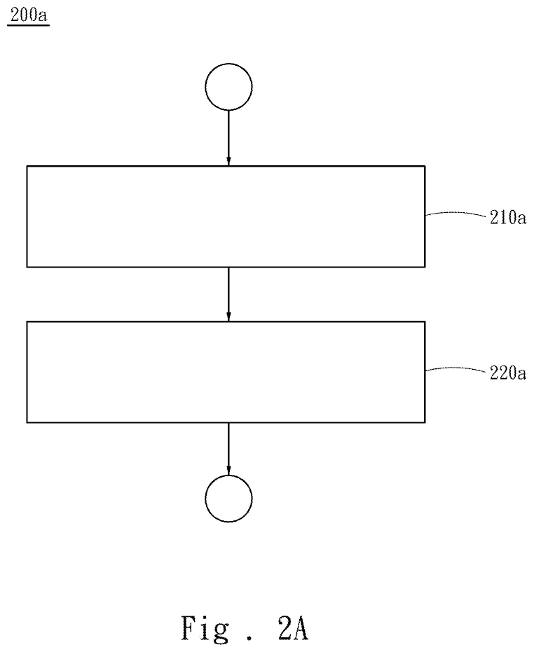

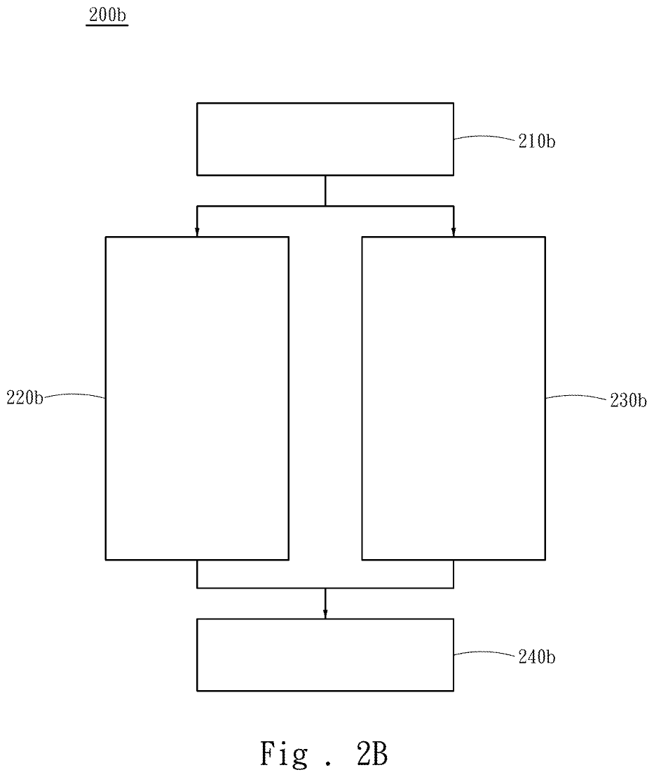

After the above initialization settings are completed, a dual-branch modeling mode of the object is turned on. Please refer to FIG. 1B, FIG. 2A and FIG. 2B, the dual-branch modeling of the object refers to branch one prediction hypothesis model modeling and branch two prediction hypothesis model modeling.

Branch One Prediction Hypothesis Model Modeling

The flow of branch one modeling in the present invention includes: a data preprocessing step a of step 200a, a similarity analysis step of step 300a, and performing a subsequent step 400a, i.e., the modeling and prediction of the branch one prediction hypothesis model, according to the above two steps.

In the data preprocessing step a of step 200a, the monitoring data of the object of the new machine is converted into the same feature format as before modeling the reference hypothesis model constructed in the SPHM system 10.

The similarity analysis step of step 300a is performed by reference to a reference hypothesis model indicator established in the mapping table, and according to a feature data sample of each reference hypothesis model before modeling. The reference hypothesis model whose modeling feature similarity exceeds a threshold value is selected according to the similarity indicator as the “branch one prediction hypothesis model” of the object (step 400a).

The similarity analysis of step 300a refers to quantizing the similarities by calculating a feature distance, and the hypothesis model with the highest similarity to the modeling feature of a certain reference hypothesis model is selected from the reference hypothesis models constructed in the SPHM system 10 as a branch one prediction hypothesis model of the object. In this step, the feature distance calculation methods of various spaces can be used to quantify the similarities, and this technique is well known to those skilled in the art, and therefore will not be described here.

However, if a similarity indicator value between the feature data after the monitoring data of the new machine is converted and the feature data before modeling the reference hypothesis model constructed in the SPHM system 10 is less than a specified threshold, it is indicated that the reference hypothesis models constructed in the SPHM system 10 do not include a hypothesis model applicable to the new machine. Then, a feature matrix consisting of the CP and the APs obtained by the LAP analysis step of step 300b of branch two is used temporally as a feature of the branch one prediction hypothesis model (step 400a) modeling step of the object. After the model adaptive optimization step (step 500) is performed and the maintenance record labels are obtained, the branch one prediction hypothesis model of the object is reconstructed according to the supervised learning method. At last, a hypothesis model is added to a SPHM object container. The SPHM object container is placed in a mapping table of the SPHM-OAT module 30. The feature sample data of model modeling corresponding to the SPHM object container is stored in the file system module 50. Therefore, the prediction hypothesis model of branch one can be automatically expanded. The supervised learning method mentioned above refers generally to support vector machine (SVM), regression, random forest or the like. The functions, types, actual quantification and analysis modes of the above methods are well known to those skilled in the art and will not be described here.

Branch two Prediction Hypothesis Model Modeling

The flow of branch two prediction hypothesis modeling in the present invention includes: a data preprocessing step b of step 200b, a LAP analysis step of step 300b, and performing a subsequent step 400b, i.e., the modeling and prediction of the branch two prediction hypothesis model, according to the above two steps.

In step 200b, a data cleaning step (refer to step 210b of FIG. 2B) is used to process the monitoring data of the object into a usable state. The data cleaning step includes, but is not limited to, data alignment, missing value processing, error data correction, and other similar related steps. The functions, types, and actual operation modes of the data cleaning step are well known to those skilled in the art and are not described herein.

Subsequently, a statistical feature processing step (refer to step 220b of FIG. 2B) and a mixed feature processing step (refer to step 230b of FIG. 2B) are performed. Various statistical features are generated according to statistical methods, such as a maximum value, a minimum value, an average value, a variance, kurtosis, skewness, and the like; various linear conversion features are generated according to feature extraction methods, such as principal components analysis (PCA), independent components analysis (ICA), and the like; mixed features are generated and a feature set is obtained according to machine learning methods, such as a neural networks (NNs) algorithm, a least absolute shrinkage and selection operator (LASSO) algorithm, and the like.

Next, the LAP analysis step is performed according to step 300b. The collected feature sets are first divided into CP sets and non-CP sets. Effective LAPs of the CP of the object of the new machine is found out according to causality test, for example, Granger causality test.

With respect to the above-mentioned CP and the effective LAP, in simple terms, the variation of one CP is caused by one effective LAP, that is, the effective LAP has a leading response capability for the CP. Then, the prediction hypothesis model is constructed by trend modeling techniques such as a regression model and an autoregressive integrated moving average (ARIMA) model; the branch two prediction hypothesis model of the object is constructed by ensemble learning. At last, a hypothesis model is added to a SPHM object container. The SPHM object container is placed in the mapping table of the SPHM-OAT module 30. The feature sample data of model-modeling corresponding to the SPHM object container is stored in the file system module 50. Therefore, the branch two prediction hypothesis model of the object can be automatically expanded. The above-described methods of feature generation, feature conversion, trend modeling techniques, regression model, ARIMA model, and ensemble learning are well-known to those skilled in the art and are therefore not described herein.

Dual-Branch Modeling Embodiment

FIG. 1B illustrates a flowchart of a modeling method for a smart prognostics system according to an embodiment of the present invention. In the present embodiment, it is assumed that branch two is a golden model in the past training experience. Therefore, in the step 110 of the first step, the branch two prediction model is preferentially selected as a golden model according to the past training experience.

Then, in step 120, the first n pieces of monitoring data set X of the objects of new machine equipment are acquired, wherein each of monitoring data set X of the object includes a plurality of monitoring values Xij, in which, i indicates an i-th monitoring parameter, and j indicates j-th piece of monitoring data. The monitoring data set X of the objects are in one-to-one correspondence to different monitoring points.

Next, the data preprocessing steps 200a and 200b of the dual-branch modeling are implemented. The data preprocessing steps 200a and 200b of dual branches of the object aim to filter invalid or nonpowerful monitoring data, and convert the usable monitoring data into a data format applicable to subsequent steps of branch one and/or to branch two. For example, the monitoring data of a sensor on a particulate filter on a MOCVD machine can be converted into a data format applicable to a subsequent similarity analysis step 300a via the data preprocessing step 200a; or the monitoring data can be converted into a data format applicable to subsequently finding LAP analysis step 300b via the data preprocessing step 200b.

The preprocessing step 200a of branch one and the preprocessing step 200b of branch two are explained below respectively.

Referring to FIG. 2A for the preprocessing step 200a, first, step 210a is implemented to select a set of feature matrixes after feature engineering is performed before modeling from the hypothesis models pre-stored in the SPHM system. Next, the monitoring data acquired in step 200a is converted into a feature matrix of the same format as the feature matrix after the feature engineering is performed before modeling (i.e., step 220a).

Referring to FIG. 2B for the preprocessing step 200b, first, step 210b is implemented to perform the data cleaning step as previously described. Next, a statistical feature processing step 220b and a mixed feature processing step 230b are implemented. At last, step 240b is implemented to place all features in a feature pool as the basis for the LAP analysis step 300b in the next phase.

Next, the similarity analysis step 300a of branch one and the LAP analysis step 300b of branch two will be described.

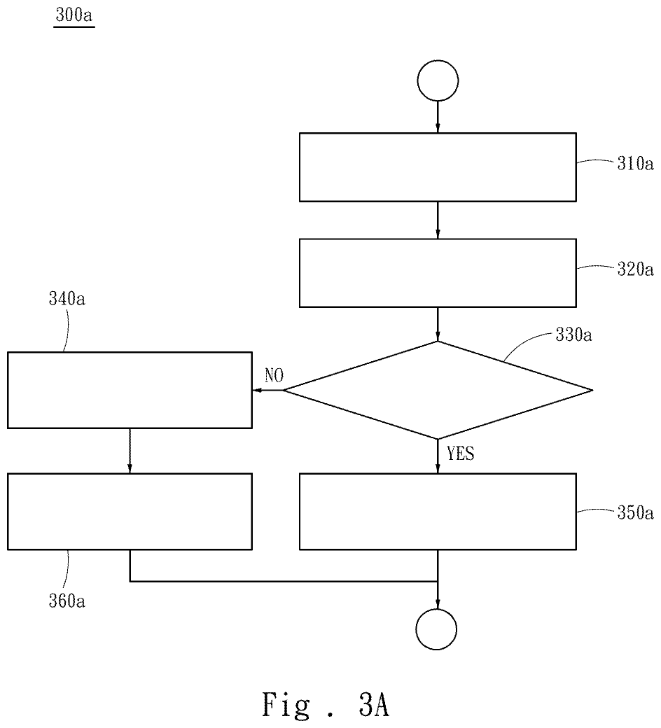

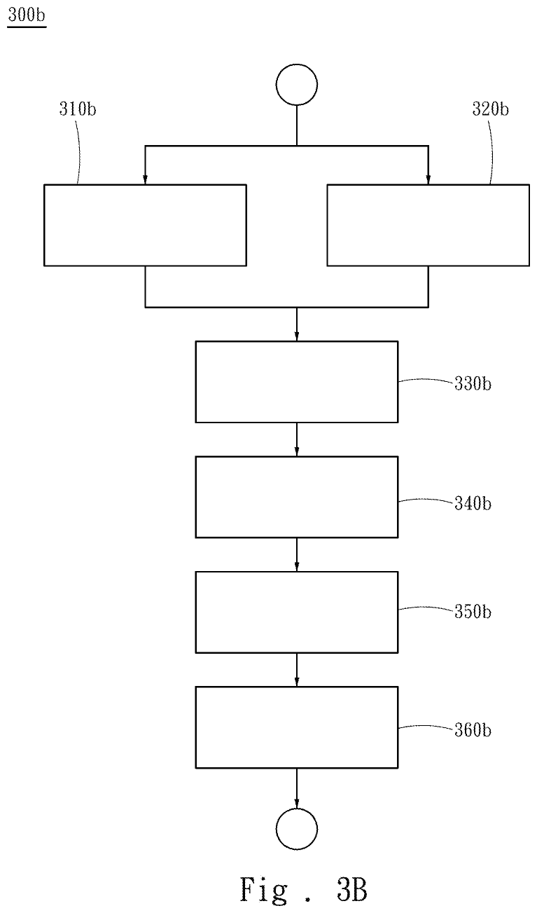

FIG. 3A illustrates a flowchart of the similarity analysis step 300a of branch one according to an embodiment of the present invention. This similarity analysis step 300a of branch one aims to learn whether there is a hypothesis model suitable for analyzing the new machine equipment among the hypothesis models pre-stored in the SPHM system of the present invention (step 330a). After the above similarity analysis, if there is a feature set among the pre-stored hypothesis models before a hypothesis model is modeled has a similarity higher than a threshold value and a closest space distance with the feature matrix after monitoring data of the specific object is converted, it is indicated that the hypothesis model is applicable to the prediction of the specific object of the new machine (step 350a). Examples of quantitative mode applicable to the similarity analysis step 300a may include: Eucledian Distance, Mahalanobis Distance, Manhattan Distance, Minkowski distance, Cosine Similarity and the like. The functions and types of these modes are well-known to those skilled in the art and are not described here.

However, in another case, if the similarity comparison result is lower than the threshold value, it is indicated that there is no hypothesis model applicable to the new machine among the pre-stored reference hypothesis models. In this case, a feature matrix consisting of the CP and the APs of the LAP analysis step 300b of branch two is utilized (step 340a), and meanwhile, the supervised learning hypothesis method (step 360a) as the modeling basis for modeling the branch one prediction modeling step 400a in the branch one.

After the step 400a is completed, a hypothesis model index of model modeling of the object may be added or updated to the mapping table of the SPHM-OAT module 30, and the branch one prediction hypothesis model of the object is expanded or updated.

FIG. 3B illustrates a flowchart of the LAP analysis step 300b of branch two according to an embodiment of the present invention. The LAP analysis step 300b includes a CP setting step 310b, a feature parameter setting step 320b, a feature selection step 330b, a causality analysis step 340b, an AP setting step 350b and a LAP generation step 360b.

First, in the CP setting step 310b and the feature parameter setting step 320b, after the monitoring data of the object is cleaned, an expert in the art specifies the CP, and then converts the data into a statistic feature and a mixed feature via the feature extraction method (see step 220b and step 230b in FIG. 2B). Other parameters different from the CP constitute a parameter which is most related to the CP.

These features constitute a huge feature set. The feature set is classified as a CP set and a feature set without CP feature. Next, an effective LAP of the CP is found out in the causality analysis step (step 340b) via Granger Causality Test.

If the feature set is oversized, the feature selection step (step 330b) is implemented instead, in which a feature which is most related to the CP is selected, and then subjected to Granger causality test to obtain a test result as the basis for the branch two prediction hypothesis model modeling step (step 400b) of the object.

After the step 400b is completed, a hypothesis model index of modeling of the object may be added or updated to the mapping table of the SPHM-OAT module 30, and the branch two prediction hypothesis model of the object is expanded or updated.

With respect to the analysis flows of the above-described Granger causality test step 400b and the branch two hypothesis model modeling step 400b, first, it is assumed that the CP and one selected AP are of a stationary time series. The null hypothesis is “the AP is not the Granger cause of the CP”, and an autoregressive model on CP (AR model on CP) is established, as shown in the following formula 1:

CPₜ=CPₜ₋₁+ . . . +CPₜ₋ₘ+errorₜ [Formula 1]

in which, CPt represents a CP observation value at time t; according to the F-test, if the explanatory power of the autoregressive model can be improved after the CPt in the lagging phase is added to the model, the lagging phase will be then keep in the model, wherein in represents the earliest time when the CP variable is tested to be significant in the lagging phase and errort is an estimated error item.

The lagging phase of the AP is added to establish a model as Formula 2:

CPₜ=CPₜ₋₁+ . . . +CPₜ₋ₘ+APₜ₋ₚ+APₜ₋ₚ₋₁+ . . . +AP_{t-q}+error [Formula 2]

Similarly, according to the F-test, if the explanatory power of the model can be improved after the lagging phase of the AP is added to the model, the lagging phase will be keep in the model. Wherein, p represents the earliest time when the AP variable is tested to be significant in the lagging phase; q represents the most recent time when the AP variable is tested to be significant in the lagging phase.

If no lagging phase of the AP is left in the model, the null hypothesis without Granger causality will be set up.

If the AP has a causal relationship with the CP, the AP is included in an AP candidate set.

Finally, all the APs in the AP candidate set are further subjected to the F-test once by the following two models (Formula 3 and Formula 4) to determine how long the AP can make a response on changes of the CP as early as possible. Formula 3 has one more phase of data APt-q than Formula 4. Therefore, in the case of comparing the results of Formula 3 and Formula 4, it can be determined whether there is a difference with the one more phase of data, and if so, it is indicated that the one more phase of data is available data.

CPₜ=CPₜ₋₁+ . . . +CPₜ₋ₘ+APₜ₋ₚ+APₜ₋₂+ . . . +AP_{t-(q-1)}+AP_{t-q}+errorₜ [Formula 3]

CPₜ=CPₜ₋₁+ . . . +CPₜ₋ₘ+APₜ₋ₚ+APₜ₋₂+ . . . +AP_{t-(q-1)}+errorₜ [Formula 4]

Finally, we select the AP that may make earliest response on the changes in the CP as an LAP.

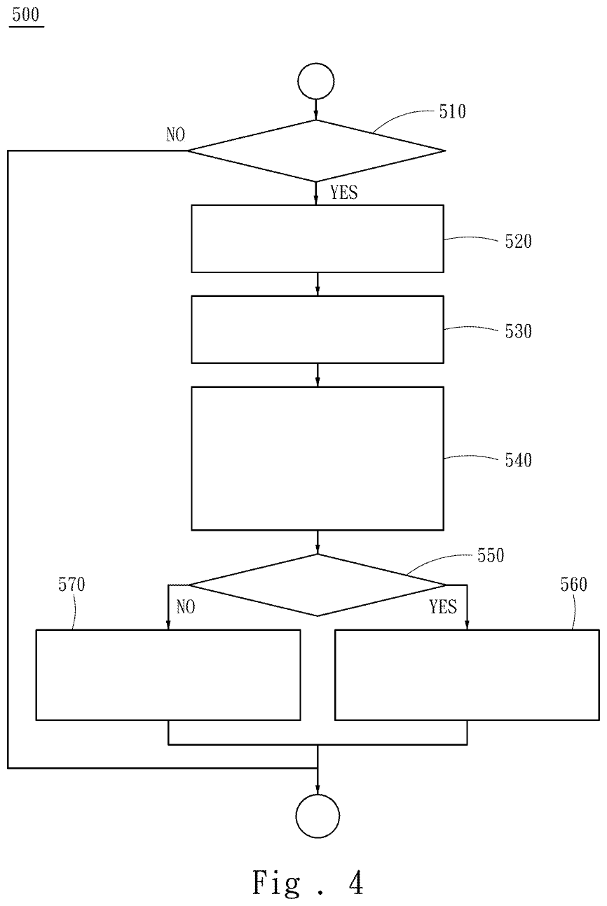

The example of the model adaptive optimization step (an adaptive switchover mechanism, step 500) mentioned in FIG. 1B refers to FIG. 4.

First, the step 510 is implemented to determine “whether a machine cannot continue the maintenance and operation”. If the determination result is “Yes”, step 520 is implemented to acquire monitoring data and maintenance records of the current object of the monitoring point. The maintenance records are in one-to-one correspondence to the respective piece of monitoring data. Each object has at least one monitoring point. Each maintenance record yi includes a maintenance status value of the at least one monitoring point. With respect to a specific example, one object may represent a metal-organic chemical vapor deposition (MOCVD) machine which comprises k monitoring points, i.e., one object (equipment) at least includes monitoring points such as current, voltage, vibration frequency, or the like.

Next, step 530 is implemented to calculate model evaluation indexes (MEI) of branch one and branch two. Common model evaluation indexes include, but are not limited to accuracy, recall rate, F value, area under ROC curve, and the like.

Subsequently, steps 540 and 550 are implemented to determine whether a model evaluation index of one branch predication model existing in the dual-branch modeling mode of the object is superior to that of the other branch model. Specifically, the steps 540 and 550 are both related to calculation. In the step 540, according to the MEI results, it is determined that whether the golden model (the golden model in the present embodiment is branch two by default) inherited from past training experience is used in the subsequent step 550.

If the MEI of the branch one hypothesis model is superior to that of the branch two prediction hypothesis model for in consecutive times according to the analysis result, step 560 is implemented, i.e., the branch one prediction model is selected as a golden model of the object, and the system is subjected to prognostics analysis. On the contrary, if the MEI of the branch one hypothesis model is not superior to that of the branch two model for in consecutive times, step 570 is implemented, i.e., the branch two hypothesis model is selected as a golden model, and the system is subjected to prognostics analysis. The monitoring data of the object is converted into the same feature format as in step 300a. Finally, the branch one prediction model is reconstructed. The hypothesis model index of the object is added or updated to the mapping table of the SPHM-OAT module 30 to expand or update the branch one hypothesis model.

The above embodiments may be implemented by using a computer program product. More specifically, the embodiments may be implemented by using a system readable medium including a plurality of instructions, that may serve as a computer program product, to perform the steps in the above embodiments. The system readable medium including the plurality of instructions includes, but is not limited a floppy disc, an optical disc, a read-only optical disc, a magneto-optical disc, a read-only memory, a random access memory, an erasable programmable read-only memory (EPROM), an electrically erasable read-only memory (EEPROM), an optical card, magnetic card, a flash memory, or any machine readable medium applicable to storing electronic instructions. Alternatively, the SPHM system 10 may also be downloaded as the computer program product, and may be transferred remotely to a local computer via a data signal in communication with network connection, and the like.

According to the system and the method provided by the present invention, it is possible to perform prediction analysis quickly from a small number of new machines without maintenance records by effectively utilizing the dual-branch modeling mode. As monitoring data and corresponding maintenance records increase, after the SPHM system of the present invention determines the result of “whether the machine cannot continue the maintenance and operation” of each object as “Yes”, the prediction hypothesis models of branch one and branch two are compared. When it is determined that the MEI of one branch prediction model existing in the dual-branch model is superior to the other prediction model for in consecutive times, this better branch prediction model is set as a golden model of the object and subjected to optimal decision, such that the prediction result of the SPHM system meets an expected target value.

1. A modeling method for a smart prognostics and health management system, the modeling method performed through the smart prognostics and health management system in which a plurality of reference hypothesis models are constructed, the method comprising:
a new tree establishing step: defining at least one object according to a machine to be monitored, and each object acquiring a monitoring data via at least one monitoring point;
a dual-branch modeling step: performing a data preprocessing step a in a branch one to convert the monitoring data into a specified feature format, and performing a similarity analysis to select a reference hypothesis model with the highest similarity and exceeding a specified threshold from the reference hypothesis models as a branch one prediction hypothesis model of the object; at the same time, performing a data preprocessing step b on the monitoring data in a branch two to confirm a critical parameter (CP) and a plurality of associated parameters (AP) corresponding to the object by using a causal relationship test and construct a hypothesis model applicable to the machine to be monitored as a branch two prediction hypothesis model of the object; and
a model adaptive optimization step: as the monitoring data is continuously generated, determining “whether the machine cannot continue the maintenance and operation” via the object and generating a determination result, if the determination result is “Yes”, a golden model is selected from the branch one prediction hypothesis model or the branch two prediction hypothesis model constructed by the dual-branch modeling step as a benchmark for optimization decision of the object, such that a prediction result of the system meets an expected target value.

2. The modeling method according to claim 1, wherein in the new tree establishing step, the machine to be monitored is a new machine without maintenance records.

3. The modeling method according to claim 1, wherein in the branch one of the dual-branch modeling step, the specified feature format has the same feature format as before the reference hypothesis model is modeled.

4. The modeling method according to claim 3, wherein the model adaptive optimization step, after the golden model is selected, further comprises: converting the monitoring data into the specified feature format and updating it to the reference hypothesis models constructed in the smart prognostics and health management system.

5. The modeling method according to claim 1, wherein the model adaptive optimization step further comprises: acquiring at least one maintenance record that includes a maintenance status value of at least one monitoring point, the monitoring data being in one-to-one correspondence to the maintenance record.

6. The modeling method according to claim 1, wherein in the branch one of the dual-branch modeling step, the similarity analysis uses at least one selected from a group consisting of Eucledian Distance, Mahalanobis Distance, Manhattan Distance, Minkowski distance, and Cosine Similarity, and combinations thereof, as a quantification method for the similarity analysis.

7. The modeling method according to claim 1, wherein in the branch one of the dual-branch modeling step, when the result of the similarity analysis does not exceed the specified threshold, a feature matrix consisting of the CP and the plurality of APs confirmed by the branch two is first used as a basis for modeling the branch one prediction hypothesis model; and in the model adaptive optimization step, after a maintenance record label is acquired, the branch one prediction hypothesis model is reconstructed according to a supervised learning method.

8. The modeling method according to claim 7, wherein the supervised learning method includes at least one selected from a group consisting of a support vector machine (SVM), regression, random forest, and a combination thereof.

9. The modeling method according to claim 1, wherein in the model adaptive optimization step, when the branch one prediction hypothesis model is superior to the branch two prediction hypothesis model for m consecutive times, the branch one prediction hypothesis model is set as the golden model; when the branch one prediction hypothesis model is not superior to the branch two prediction hypothesis model for m consecutive times, the branch two prediction hypothesis model is selected as the golden model.

10. The modeling method according to claim 9, wherein in the model adaptive optimization step, the m value is a positive integer greater than 2.

11. A computer program product for a smart prognostics and health management system, wherein the modeling method for the smart prognostics and health management system according to claim 1 is completed when the computer program product is executed.
